(19) United States
(12) Patent Application Publication
(10) Pub. No.: US 2026/0111021 A1
(43) Pub. Date: Apr. 23, 2026

(54) AI MODEL RETRAINING WITH DATA DISTRIBUTION SHIFT AWARENESS

(71) Applicant: Advanced Micro Devices, Inc., Santa Clara, CA (US)

(72) Inventors: Yao Cui FEHLIS, New Braunfels, TX (US); Tushar CHOUHAN, Singapore (SG); Arun Kumar CHANDRAN, Singapore (SG)

(21) Appl. No.: 18/922,020

(22) Filed: Oct. 21, 2024

(51) Int. Cl. G05B 23/02

(52) U.S. Cl. CPC G05B 23/0283

(57) ABSTRACT

Embodiments herein use data synthesis to generate data distributions that predict how input data for a digital twin of a manufacturing process may drift as conditions change in the manufacturing process (e.g., tool deterioration, a change in materials, a design change, etc.). These different predicted data distributions can then be used, a priori, to build AI model variants (e.g., pre-trained AI models) for the digital twin. Thus, when input data drift is detected in the manufacturing process, the system can select one of the AI model variants to use which was built (or trained) using a data distribution that is similar to the new input data.

### TECHNICAL FIELD

Examples of the present disclosure generally relate to AI model retraining strategies to respond to shifts in input data to an AI model in a digital twin for a manufacturing process.

### BACKGROUND

AI model retraining is typically triggered when inference accuracies are not satisfactory. In some cases, engineers periodically retrain the model even when not necessary, leading to increased costs.

### SUMMARY

One embodiment described herein is a method that includes detecting a drift in input data used in a digital twin of a manufacturing process where the digital twin includes an initial artificial intelligence (AI) model and, upon determining that a first one of a plurality of already trained AI models, or a first one of a plurality of previously trained branches in the initial AI mode, was trained using a data distribution that is similar to the drift in the input data, selecting the first trained AI model or the first branch in the initial AI model to use in the digital twin.

One embodiment described herein is computer readable medium comprising instructions which, when executed by a processor in a computing system, perform an operation. The operation includes detecting a drift in input data used in a digital twin of a manufacturing process where the digital twin includes an initial AI model and, upon determining that a first one of a plurality of already trained AI models, or a first one of a plurality of previously trained branches in the initial AI mode, was trained using a data distribution that is similar to the drift in the input data, selecting the first trained AI model or the first branch in the initial AI model to use in the digital twin.

One embodiment described herein is a computing system that includes one or more processors and one or more computer-readable storage media with program instructions stored on the one or more storage media to cause the one or more processors to perform operations. The operations include detecting a drift in input data used in a digital twin of a manufacturing process where the digital twin includes an initial AI model and, upon determining that a first one of a plurality of already trained AI models, or a first one of a plurality of previously trained branches in the initial AI mode, was trained using a data distribution that is similar to the drift in the input data, selecting the first trained AI model or the first branch in the initial AI model to use in the digital twin.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a workflow for synthesizing samples using a digital twin, according to an example.

FIG. 2 illustrates tracking AI model inference accuracy to trigger retraining, according to one embodiment.

FIG. 3 illustrates a workflow for synthesizing samples using a digital twin to combine with real-world samples, according to an example.

FIG. 4 is a flowchart for proactively training AI models for predicted shifts in an input data distribution, according to one embodiment.

FIG. 5 illustrates generating synthesized samples using feature perturbation, according to one embodiment.

FIG. 6 illustrates generating synthesized samples for predicted shifts in an input data distribution, according to one embodiment.

FIG. 7 is a flowchart for switching between models in response to drifts in an input data distribution, according to one embodiment.

FIG. 8 is a flowchart for retraining a current AI model or building a new AI model in response to drifts in an input data distribution, according to one embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein use data synthesis to generate data distributions that predict how input data for a digital twin of a manufacturing process may drift as conditions change in the manufacturing process (e.g., tool deterioration, a change in materials, a design change, etc.). These different predicted data distributions can then be used, a priori, to build AI model variants (e.g., already trained AI models) for the digital twin. Thus, when input data drift is detected in the manufacturing process, the system can select one of the AI model variants to use which was built (or trained) using a data distribution that is similar to the new input data. Advantageously, this avoids having to retrain the current AI model in the digital twin, or having to build a new AI model. Having a repository of trained AI models to select in response to input data drift can reduce downtime in the manufacturing process, improve the quality of the product being produced by the manufacturing process, and the like.

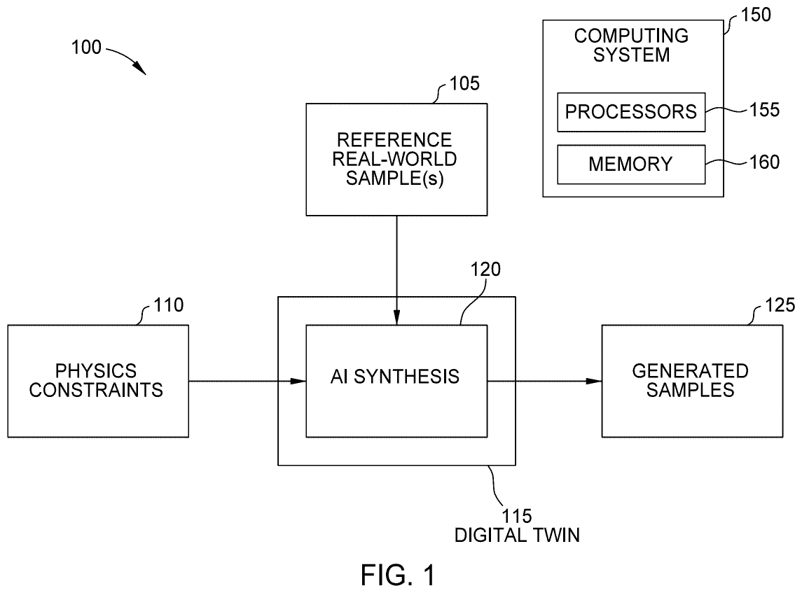

FIG. 1 illustrates a workflow 100 for synthesizing samples using a digital twin, according to an example. The workflow 100 includes a digital twin 115 (e.g., a software application) that performs AI synthesis 120 to generate samples 125. The types of AI synthesis 120 can include signal data (e.g., voltage or current profiles), image data (e.g., scanning electron microscope (SEM) images of a semiconductor wafer or integrated circuit (IC) packages on a substrate), images of signal data (e.g., signal probing at discretized points on a wafer that is visualized as a spatial distribution), or design data (e.g., metal density spatial distribution). The generated samples 125 can include design samples used to manufacture an IC, test signal samples used to determine if a wafer has a fault, failure samples, or a set of parameters which define a manufacturing lifecycle.

In this example, the AI synthesis 120 uses both real-world samples 105 and physics constraints 110 to generate the samples 125. In one embodiment, the real-world samples 105 include historical data, which can include historical fault data, historical test data (e.g., from previously tested semiconductor wafers), or design data from previous IC designs. The real-world samples 105 may also be output data provided by tools or machines that are performing the manufacturing process.

The reference real-world samples 105 not only serve as a good starting point (to address the cold start problem in synthesis) but also guides the synthesis to generate data samples 125 which have feature distributions similar to them—e.g., wafer substrate spatial distributions which have relative component placement locations similar to real-world samples 105. In one embodiment, historical real-world samples from the past products/manufacturing lifecycle are also considered as reference real-world samples 105. These historical samples can be compared against the reference real-world samples to select relevant historical samples to use for AI synthesis 120.

The physics constraints 110 can limit the synthesis of data samples to guide the synthesis towards feasible samples 125. The physics constraints can include geometry constraints or electrical signal constraints. In general, the constraints 110 can include any type of physical constraints used in testing, design, or modeling a device (e.g., a semiconductor device or an electronic device).

FIG. 1 also illustrates a computing system 150 which includes one or more processors 155 and memory 160. The computing system 150 can be a single computing device (e.g., a server or desktop computer) or network of computing devices (e.g., a data center or cloud computing environment). The processors 155 can have any number of processing cores, and the memory 160 can include volatile memory elements, non-volatile memory elements, and combinations thereof.

In one embodiment, the computing system 150 executes the workflow 100. That is, the physics constraints 110, the real-world samples 105, and the generated samples 125 can be stored in the memory 160. The processors 155 can then execute the AI synthesis 120 in the digital twin 115 to generate the samples 125 using the real-world samples 105 and the physics constraints 110 as inputs. The processors 155 can be general purpose processors (e.g., CPUs), graphic processing units (GPUs), or specialized application specific integrated circuits (ASICs) designed to perform AI synthesis 120.

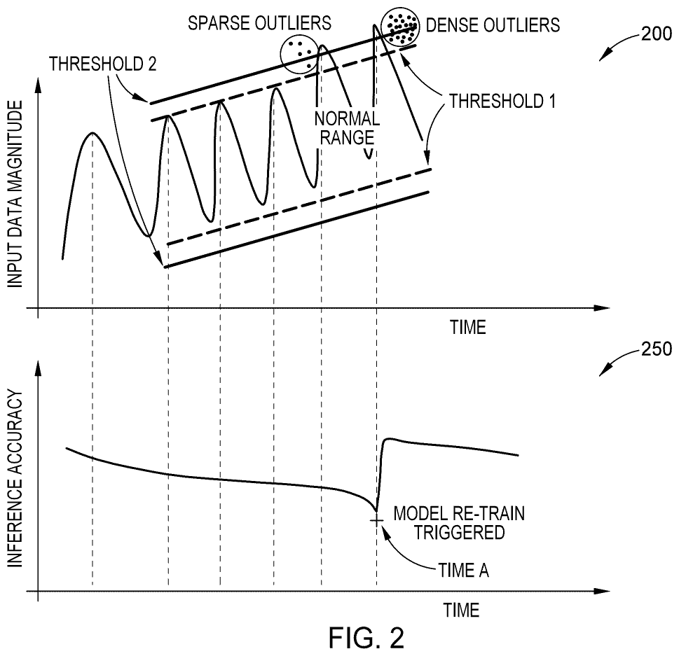

FIG. 2 illustrates tracking AI model inference accuracy to trigger retraining, according to one embodiment. For example, the AI model used to perform the AI synthesis 120 in FIG. 1 may need to be retrained as the input data varies (i.e., as the input data distribution shifts or drifts). That is, the AI synthesis may be trained to synthesize data for a particular input data distribution, but if the input data distribution shifts, the accuracy of the AI model used to perform AI synthesis decreases.

Chart 200 in FIG. 2 illustrates the variation of input data magnitude to an AI model (e.g., AI synthesis) over time. The chart 200 illustrates a normal range, a first Threshold 1, and a second Threshold 2. If the input data magnitude stays within the normal range, then the accuracy of the AI model is maintained. However, the chart 200 illustrates the input data begins to shift. While some of the input data may exceed Thresholds 1 and 2, these are sparse outliers which may not have a significant impact on the accuracy of the output of the AI model. However, dense outliers in the input data can cause larger shifts in the input data magnitude or distribution.

Chart 250 illustrates the change in the inference accuracy of the AI model over the same time period as chart 200. As the input data magnitude changes as shown in chart 200, the inference accuracy of the model drops. Eventually, at Time A, the accuracy drops below a threshold and a model re-train is triggered. This causes the accuracy of the AI model to increase.

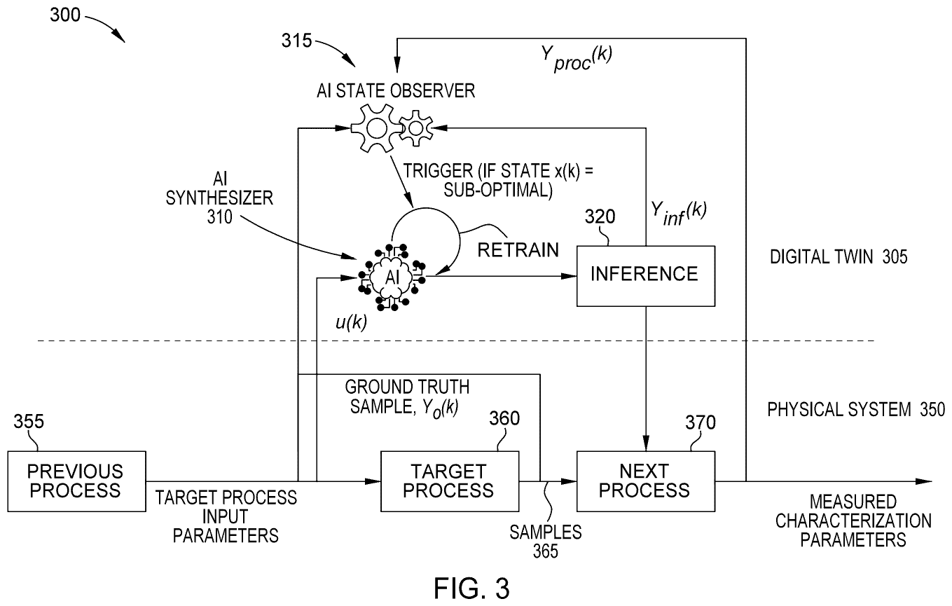

FIG. 3 illustrates a workflow 300 for synthesizing samples using a digital twin 305 to combine with real-world samples, according to an example. In this example, the workflow 300 is divided into the digital twin 305 and a physical system 350, where the digital twin 305 includes the components and data above the dotted line and the physical system 350 includes the components and data below the dotted line.

As shown, the digital twin 305 includes AI synthesizer 310, inference 320 (which creates “generated samples” or “synthesized samples”), and an AI state observer 315. The physical system 350 includes a previous process 355, a target process 360, and a next process 370. For ease of explanation, the workflow 300 is discussed in the context of a semiconductor wafer fabrication system but this is just one example of where the workflow 300 can be used. The system could be used in any physical manufacturing process where resulting devices (e.g., circuits or electronic devices such as smartphones, televisions, computers, etc.) are tested or evaluated.

For example, the previous process 355 may be one or more steps in a semiconductor fabrication process which can include deposition, etching, patterning (using masks), etc. The target process 360 can be a test process where images are captured on the semiconductor wafer, probe measurements are taken, and/or test signals are recorded. FIG. 3 illustrates transmitting physics constraints and input parameters to both the target process 360 and the AI synthesizer 310. These constraints and input parameters can include the parameters or configurations of the test being performed by the target process 360 such as where to capture the images, where to probe the semiconductor wafer, what voltages/currents to use when testing the wafer, etc. Thus, in this example, the AI synthesizer 310 in the digital twin 305 receives the same constraints and input parameters as the target process 360 in the physical system 350.

The target process 360 and the AI synthesizer 310 can execute using the constraints and input parameters. The target process then generates the sample 365 that capture the results of the target process 360 which are passed to the next process 370. For example, the samples 365 can include the captured images, probe measurements, or recorded testing signals generated from testing the semiconductor wafers.

In addition to using the constraints and parameters as inputs, the AI synthesizer 310 can also receive reference real-world samples as inputs. In one embodiment, the reference real-world samples are generated from the physical samples 365 generated by the physical target process 360. However, in one embodiment, the reference real-world samples are generated from past tests of previous semiconductor wafers. Stated differently, the real-world samples can be historical data generated by testing previous wafers.

The AI synthesizer 310 uses the inputs to perform inference 320 and generate the synthesized samples. The samples generated by the AI synthesizer 310 are then provided to inference 320 (e.g., an inference engine), to make predictions on the results of the target process. These predictions, along with the real samples 365 generated by the target process 360, are provided to the next process 370.

As discussed, the AI synthesizer 310 generates samples that are used as input to the inference engine. In one embodiment, the next process 370 does not directly use the samples generated by the AI synthesizer 310, but instead the output of the inference 320 on the artificial samples generated by the AI synthesizer 310. Therefore, the digital twin 305 is used to predict the outcome of the target process 360. For the case where the target process 360 involves testing, which is typically a costly process, it can be done on a smaller subset of the real samples; while a larger set of predicted outcomes are made available via the digital twin's inference 320.

Using AI synthesis in the digital twin 305 to generate predicted outcomes of the target process 360 has several advantages. First, the target process 360 can be a less intensive testing process. For example, in previous solutions for testing wafers, the target process 360 may have tested the entire wafer. That is, the testing process may have captured images of the entire wafer, or probed the entire wafer to identify any faults in the wafer. With the workflow 300, the target process 360 may captures images of, or probe, only a few regions of the wafer. The generated samples from the digital twin 305 of the wafer can then be used to generate samples for the remaining portions of the wafer. Thus, the target process, which typically takes much longer than performing AI synthesizer 310, can be reduce in time and scope.

Second, testing wafers is expensive. Thus any techniques for reducing the time or equipment used for the test can result in substantial savings to the overall fabrication process.

In one embodiment, the next process 370 determines whether the wafer tested by the target process 360 has a fault. For example, the next process 370 can evaluate the outcomes predicted by the digital twin 305 and the real-world results generated by the target process 360 to predict whether the wafer has a fault. If so, the wafer may be tested thoroughly using a physical test to determine whether a fault actually exists. However, if the samples 365 indicate that the wafer likely does not have any faults then additional testing can be skipped. In this manner, the target process 360 can be a “light” testing process where the samples it generates are combined with the samples generated by the digital twin 305 to determine whether a “heavy” testing process should be performed by the next process 370. Wafers that pass the light testing can skip the heavy testing which can speed up the manufacturing process and save costs.

The workflow 300 is iterative, providing more samples for the physical system 350 while being guided by the physical system 350 and becoming a digital twin 305. The interaction could be with a single target process 360 or a combination of processes.

Further, the physical constraints and input parameters could change with time such as changes in design requirements, stricter quality expectations, new types of faults to analyze, and more. The samples by inference 320 evolve when these changes are considered for the next iteration of sample synthesis. The synthesized samples (or predicted results) help influence the next iteration of synthesis together with new real-world samples which, when available, can improve the quality of the generated samples. The generated samples are continuously improved with the AI synthesizer 310 guided by the real-world system in addition to just a few real-world data samples 365.

However, as introduced above, the AI synthesizer 310 can become susceptible to data distribution drift which can cause the accuracy of the inference 320 to decrease. Data distribution drift in the target process input parameters (which are the inputs to the AI synthesizer 310) can occur for any number of reasons. Some reasons for data distribution drift can be due to a known tendency of manufacturing tools used in the previous process 355 to drift (also referred to as line drift), or an effect of changes incorporated by the manufacturer to address a known fault such as changing materials used in the manufacturing process, changing a design of the product being manufactured, and the like. These drifts can affect the accuracy of the inference 320 for the AI synthesizer 310 as shown in FIG. 2. Model re-training can be used to increase the accuracy of the inference 320.

In one embodiment, model retraining is triggered by tracking the input data distributions corresponding to a satisfactory performance of inference 320 for the AI synthesizer 310. For instance, this can be achieved by projecting the embeddings outputted from the later layers of a deep neural network model used to perform the AI synthesizer 310 to a lower dimensional kernel space, or by using feature reduction methods such as by using Principal Component Analysis. Input data distributions get updated with new data being processed. As shown in FIG. 2, when a consistent and high magnitude deviation represented by a dense outlier out of the current data distribution is observed by the AI state observer 315, the observer 315 can trigger model retraining. In one embodiment, a sliding backward window approach to profile data distribution evolution could be adopted to measure the magnitude of the deviation (rate of deviation).

In the case of systems where the data distribution shift is gradual, determining when to retrain the model and the selection of the samples for retraining is important to catch up with an ongoing shift. As an example of the observer 315 triggering retraining of the AI model used by the AI synthesizer 310, assume an operating range characterization of a device is used to predict the desired current/voltage required to operate at a specific frequency. Here, the previous process 355 may be a higher-level testing and product segregation process which identifies a subset of product that needs this characterization. The target process 360 determines the current/voltage for this operating range characterization. However, the expected current/voltage cannot be determined and then measured for all the operating range frequency values at the target process 360 because it is a time-consuming process. Hence, these values are predicted (or synthesized) by the AI synthesizer 310 and its inference 320.

In one embodiment, periodic ground truth by real-world testing on random samples is available for a few samples to check if the predictions match the ground truth. The next process 370 may be a Look Up Table (LUT) which will be fused with the product with a fast simulated test to check whether the LUT leads to a desired device operation, which is the measured characterization parameters.

The AI engine with input and output inference is considered as the system here which can be a discrete-time scenario. Two states of the system are defined, optimal (does not need retraining) and sub-optimal (needs retraining) as shown by Equation 1.

$$x ( k ) = \{ optimal , sub - optimal \} \qquad ( 1 )$$

When the AI synthesizer 310 performs within expectations, the optimal state is maintained. With an additional input of a few ground truth samples periodically extracted from the physical system, the AI state observer 315 can estimate when the performance of the AI synthesizer 310 is deteriorating (shifting to sub-optimal state) and provide the time stamp when the underlying input data distribution has changed. Such a timestamp could guide the sample selection process for the model retraining and thereby reduce the input samples from before the shift in the input data distribution. A consistent sub-optimal state is identified as a shift in the input data by the AI state observer 315.

However, re-training takes time and requires significant compute resources. It also can cause the manufacturing process to stale, or the manufacturing process is more likely to generate faulty products, while waiting for the model to be retrained (or to build a new model). Thus, the embodiments herein describe techniques for proactively training AI models which perform well for deviations in the data distributions. Thus, when changes in data distributions occur, the system can pre-empt a model re-train through the synthesis of data distribution deviations (ahead of time) and selecting from a pool of already trained AI models an AI model that is suitable for the new data distribution. Note that the proposed approaches discussed herein are generalizable and can be adopted to any type of AI/ML tasks which involve temporal variations in the inputs.

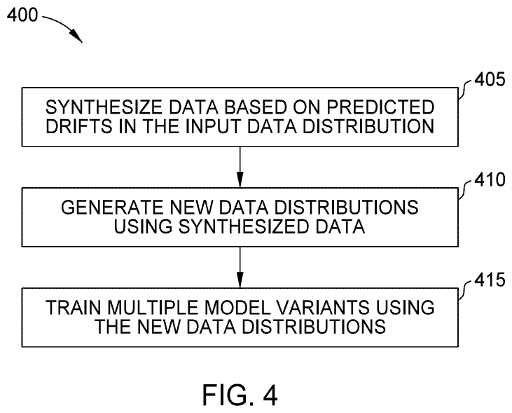

FIG. 4 is a flowchart of a method 400 for proactively training AI models for predicted shifts in an input data distribution, according to one embodiment. In one embodiment, the method 400 is performed before there is a drift in input data distribution. That is, the method 400 can be done proactively assuming that there is going to be drift in input data distribution (e.g., due to line drift, drifts in the output of the manufacturing tools, a change in materials, design changes, etc.). As discussed below, the output of the method 400 is a plurality of previously trained AI models (or an AI model with multiple trained branches) that can be used when the real-world input data distribution shifts. This enables the digital twin to adapt quickly to sudden changes in the input data distribution by switching to a model that has already been trained on a data distribution that is similar to the new data distribution.

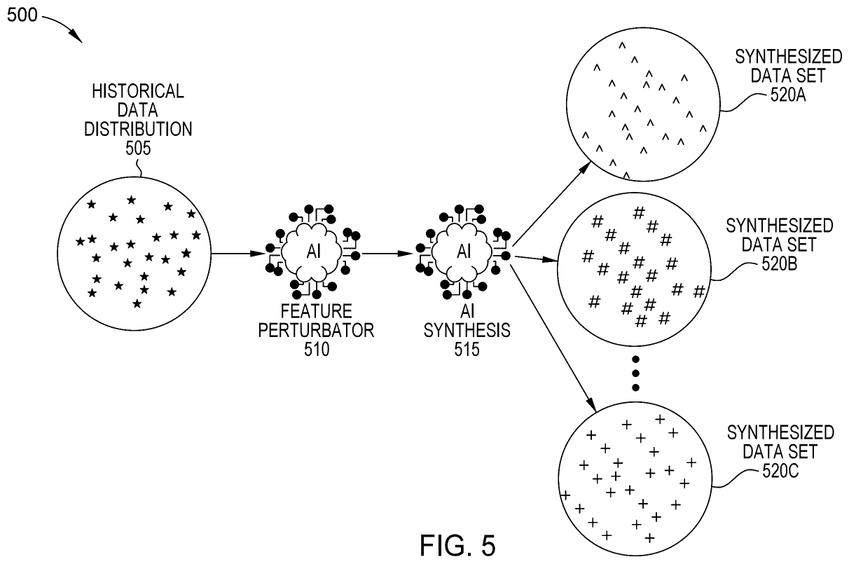

At block 405, the AI synthesis synthesizes data based on predicted drifts in the input data distribution. That is, a similar AI synthesis process used to generate synthesized samples for a next process as discussed in FIG. 3 can be used here to generate synthesized data for drifts in input data distribution. Using AI synthesis to generate predicted shifts in input data distribution is discussed in more detail in FIG. 5.

FIG. 5 illustrates generating synthesized samples for predicted shifts in an input data distribution, according to one embodiment. As shown, a historical data distribution 505 (e.g., real-world data captured from the current manufacturing process or similar manufacturing processes) is input into a feature perturbator 510 (e.g., a software application). The feature perturbator 510 can remove features from the historical distribution 505 to synthesize a new data distribution. This can be based on input from domain experts who can provide guidance to the feature perturbator 510 on which features to remove to simulate different issues that may arise (e.g., tool deterioration, change in materials, design changes, etc.). For example, the feature perturbator 510 could simulate a partially failing hardware system by intentionally removing features from current data to synthesize a new data distribution which represents a deteriorating system. The feature perturbator 510 can not only rely on the prior knowledge of the domain experts but also introduce noise in the feature value within the physical constraints to create variations of the original data points which could be unforeseen.

The “perturbed” data generated by the feature perturbator 510 is used as input to the AI synthesis 515 to generate synthesized data sets 520A-C, which include synthesized samples or data. These synthesized data sets 520 can correspond to different reasons for why the input data may drift. For instance, the synthesized data set 520A may predict the input data distribution when there is line drift, the synthesized data set 520B may predict the input data distribution when there is a change in material, and the synthesized data set 520C may predict the input data distribution when there is a design change. Or the synthesized data set 520A may predict the input data distribution when there is change to a first material, the synthesized data set 520B may predict the input data distribution when there is a change to a second material, and the synthesized data set 520C may predict the input data distribution when there is a change to a third material. This could also include different synthesized data sets for different changes to tool deterioration (e.g., when a tool shows initial signs of deterioration, when a tool has deteriorated, and when a tool is about to fail from deterioration) or different design changes (e.g., a small design change versus a large design change). In this manner, the system 500 can generate different synthesized data sets 520 for all kinds of predicted changes in a manufacturing process.

Returning to method 400, at block 410 the system generates new data distributions using the synthesized data (e.g., the synthesized data sets 520 from FIG. 5). These different data distributions can represent different predicted scenarios that can occur in the manufacturing process.

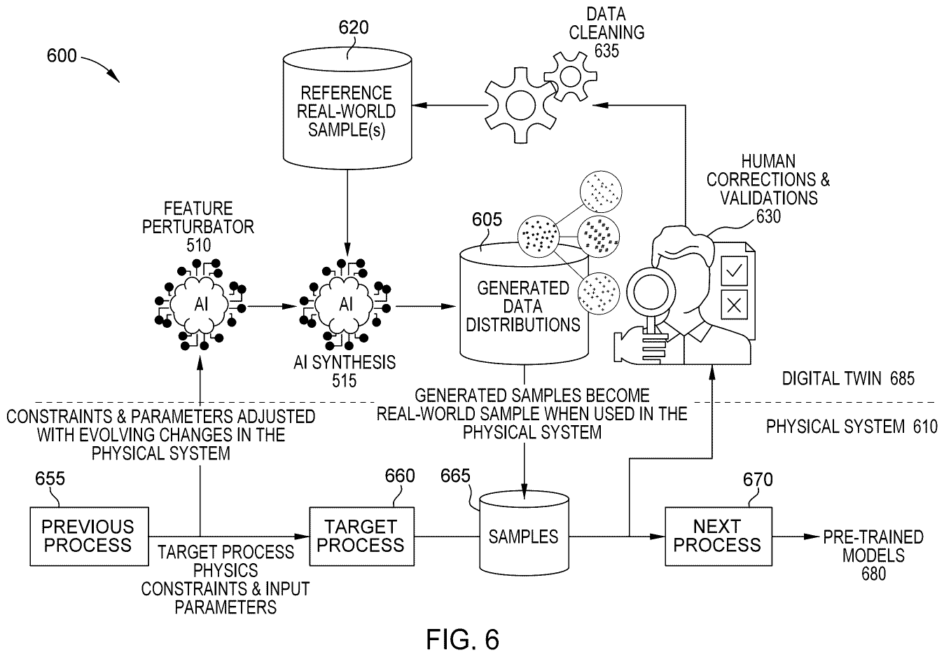

At block 415, the system trains multiple model variants using the new data distributions. Blocks 410 and 415 are discussed in more detail in FIG. 6.

FIG. 6 illustrates a system 600 for generating synthesized samples for predicted shifts in an input data distribution, according to one embodiment. The system 600 includes the feature perturbator 510 and AI synthesis 515 which were discussed in FIG. 6. However, instead of a manufacturing process, the physical system 610 has a previous process 655, a target process 660, and a next process 670 for building the AI models using the predicted data distributions 605 generated by the feature perturbator 510 and the AI synthesis 515.

In this example, building new prediction models (e.g., the previously trained models) is performed by the next process 670. The task of the target process 660 is to provide samples for prediction model training, while the task of the previous process 655 is to perform a sample extraction process which generates the original data distribution that is input to the feature perturbator 510 and the target process 660.

The synthesis approach used by the AI synthesis 515 could be AI based or heuristics based with domain expertise (provided by human input 630 and data cleaning 635) and physics constraints to control the data distribution variations for the data distributions 605.

In one embodiment, samples 665 are synthesized with a few reference real-world samples 620 and guided by the physics constraints. Human experts in the feedback loop could provide input 630 by choosing representative samples which are desirable to guide the synthesis in the expected directions. Domain information such as the sensors that could fail and the default value that will be generated (in such a case), can make the sample synthesis easier.

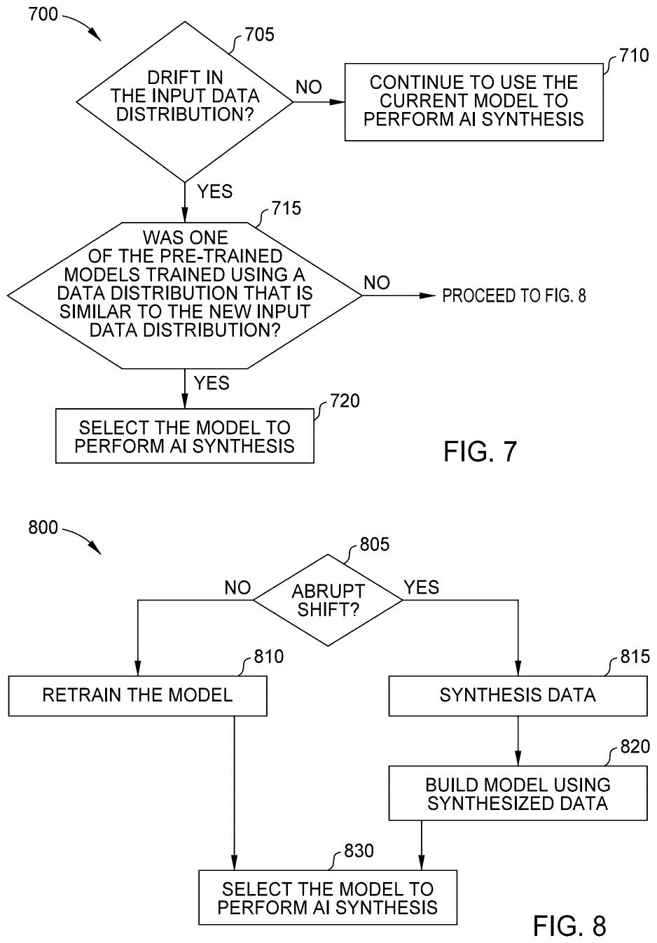

The new data distributions 605 can then be used to build trained AI models 680 (e.g., multiple model variants) which could be swapped when similar data points are observed in the real-world system, which is discussed in FIG. 7. In building such a model pool of already trained models 680 for a pre-determined set of possible data distributions 605, the system can react quickly to maintain the performance as well as aid in a graceful decline of the physical system (hardware system failures in this example) over a time period rather than a potentially dangerous and abrupt failure.

While FIG. 6 illustrates training (or building), a priori, multiple models (or multiple model variants) for each of the predicted data distribution drifts, in another embodiment, the system 600 can use the predicted data distribution drifts to generate a singular (large) model with multiple parallel expert branches which correspond to the different predicted data distributions. These expert branches of the model can each specialize in a unique deviation of the data (for example, data distribution drifts due to a known tendency of manufacturing tool drifts, or effect of changes incorporated by the manufacturer to address a known fault, etc.). That is, like the already trained model variants, the different branches can be proactively trained using different predicted data distributions.

FIG. 7 is a flowchart of a method 700 for switching between models in response to drifts in an input data distribution, according to one embodiment. In one embodiment, the method 700 occurs after the method 400 has been performed where a system (e.g., the system 600 in FIG. 6) has prepared multiple AI model variants (or a singular AI model with expert branches) in anticipation of input data distribution drifts.

At block 705, an observer (e.g., the AI state observer 315 in FIG. 3) determines whether there is a drift in the input data distribution that is input into the AI synthesis. For example, the observer could perform time series analysis of model-retraining triggers over a period of time along with external factors such as new design changes, product requirement changes, change in raw materials to determine that the input data has drifted.

In one embodiment, the observer can determine whether the AI model performing synthesis is performing within expectations. Using a handful of ground truth samples periodically extracted from the physical system, the observer can estimate when the AI model's performance is deteriorating (shifting to sub-optimal state) which can be a result of input data distribution drift.

In one embodiment, model retraining is triggered by tracking the input data distributions corresponding to a satisfactory performance of inference for the AI synthesis. This can be achieved by projecting the embeddings outputted from the later layers of a deep neural network model used to perform the AI synthesis to a lower dimensional kernel space, or by using feature reduction methods such as by using Principal Component Analysis. When a consistent and high magnitude deviation represented by a dense outlier out of the current data distribution is observed by the AI state observer, the observer can determine there is drift in the input data distribution. In one embodiment, a sliding backward window approach to profile data distribution evolution could be adopted to measure the magnitude of the deviation (rate of deviation).

If there is no drift, the method 700 proceeds to block 710 where the system continues to use the current AI model to perform AI synthesis.

If there is drift, the method 700 proceeds to block 715 where the observer determines if one of the already trained models was trained using a data distribution that is similar to the new (drifted) input data distribution. For example, the observer could determine whether the incoming input data resembles one of the synthesized data sets generated at blocks 405, 410, and 415 of method 400 which was used to build the already trained AI models. The observer can determine if the data distributions used to build the already trained AI models are similar (using a similarity threshold) to data points in the new input data distribution. In one embodiment, one or more statistical measures can be used to determine the similarity between the data distributions. For instance, measures of distance—like Kullback-Leibler divergence—between populations/distributions, or other appropriate statistical measures can be used depending on the particular application.

If so, the method 700 proceeds to block 720 where the selected trained AI model is used to perform AI synthesis. That is, the AI synthesis switches to using the new (already trained) AI model to process the input data distribution.

In the case where a large model with multiple expert branches is used, the AI synthesis can switch to the expert branch that corresponds to the input data distribution. In either case, this switch can be almost instantaneously, and will take less time than having to retrain the current AI model. This improves compute efficiency and reduces downtime in the manufacturing process since it does not have to stall while waiting for the current model to be retrained, or for a new model to be built.

However, if the observer determines the drift in the data distribution is not similar to the synthesized data distributions used to build the trained models (or the expert branches), the method instead proceeds to FIG. 8.

FIG. 8 is a flowchart of a method 800 for retraining a current AI model or building a new AI model in response to drifts in an input data distribution, according to one embodiment. The method 800 can start when one of the already trained models is not a good fit for the drift in the input data distribution. However, the method 800 can also be used independently of FIG. 7. That is, the system may not have any trained models, but instead proceed directly to method 800 when detecting a drift in the input data distribution.

At block 805, the observer determines whether there is an abrupt shift in the input data distribution. If there is a gradual shift in the input data distribution, the method 800 proceeds to block 810 where the new input data distribution is used to re-train the current AI model used in AI synthesis. Because the shift is gradual (according to some threshold of similarity to previous input data), the new input data distribution (as well as historical input data) is sufficient to retrain the current model to perform AI synthesis.

However, if the shift in the input data distribution is abrupt, then there might not be enough data to retrain the model (since the historical input data distribution cannot be used given the abrupt shift in the input data). For example, an abrupt change can have a drastic shift/deviation within a very small duration. A statistical measures can be used to define what acceptable limits or tolerance is allowed for the incoming data (for instance, the standard deviation/variance values). If the incoming samples exceed these tolerance limits within a short time duration, that would signal an abrupt shift has occurred.

On the other hand, a gradual shift could be one that has a steady and continued deviation, but within the tolerance limits. Ultimately, if this gradual shift continues it would end up violating the tolerance limits but would end up doing so over a much longer duration compared to an abrupt change. In one embodiment, a sliding window approach may also be used to determine whether we have an abrupt versus a gradual change.

In the case an abrupt shift is detected, the method 800 proceeds to block 815, where additional training data can be synthesized. In one embodiment, block 815 can use the same system described at FIG. 6 to generate synthesized data sets.

As an example of synthesizing data distributions by simulating data shifts, assume there is a deployed device which could fail over time. The required current/voltage to operate at a desired frequency should be predicted. Assume there is a set of sensor values that represent the feature set for this prediction. Based on domain knowledge, Sensor A, Sensor B and Sensor C are expected to fail over time. However, the order of the failure is unknown. Hence, with the existing dataset, feature values corresponding to the sensors can be changed to a default value (that corresponds to a failure case) to create new data distributions at block 820. Different data distributions corresponding to all possible combinations of Sensor A, B and C failures are created which can then be used to build data set variants and build the corresponding models.

Whether the current model is retrained at block 810, or a new model is built at block 820, the method 800 proceeds to block 830 where the observer selects the model to perform AI synthesis.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method comprising:
detecting a drift in input data used in a digital twin of a manufacturing process, wherein the digital twin comprises an initial artificial intelligence (AI) model; and
upon determining that a first one of a plurality of already trained AI models, or a first one of a plurality of previously trained branches in the initial AI mode, was trained using a data distribution that is similar to the drift in the input data, selecting the first trained AI model or the first branch in the initial AI model to use in the digital twin.

2. The method of claim 1, further comprising, before detecting the drift in the input data:
building the plurality of trained AI models or the plurality of trained branches from different data distributions representing different predicted scenarios that can occur in the manufacturing process.

3. The method of claim 2, wherein the different predicted scenarios comprises at least one of:
a deterioration of a tool used in the manufacturing process;
a change of material used in the manufacturing process; or
a change of design of a product produced by the manufacturing process.

4. The method of claim 2, further comprising, before building the plurality of trained AI models or the plurality of trained branches:
synthesizing data, using an AI synthesizer, based on predicted drifts in a historical data distribution corresponding to the manufacturing process, wherein the different data distributions comprise the synthesized data.

5. The method of claim 1, wherein the first trained AI model replaces the initial AI model in the digital twin, or selecting the first branch to use in the digital twin results in a second, initial branch in the initial AI model no longer being used.

6. The method of claim 1, further comprising, after selecting the first trained AI model or the first branch:
detecting a second drift in the input data used in the digital twin; and
upon determining that none of the plurality of already trained AI models, or none the plurality of previously trained branches in the initial AI mode were trained using a data distribution that is similar to the second drift in the input data, determining whether the second drift is abrupt based on one or more threshold;
the method further comprises one of:
upon determining that the second drift is not abrupt, retraining the initial AI model using current and historical input data received at the digital twin; or
upon determining that the second drift is abrupt:
synthesizing training data; and
building, using the synthesized data, a new AI model to replace the initial AI model in the digital twin.

7. The method of claim 1, further comprising:
performing, using the digital twin, artificial intelligence (AI) synthesis to generate synthesized samples for the manufacturing process based on physics constraints and historical samples;
performing the manufacturing process to generate real-world samples;
combining the synthesized samples with the real-world samples; and
analyzing the combined synthesized samples and real-world samples to determine whether additional testing should be performed as part of the manufacturing process.

8. The method of claim 7, wherein the manufacturing process comprises testing a semiconductor wafer to determine a fault, wherein the historical samples are generated by testing previous semiconductor wafers, wherein the physics constraints comprise testing parameters for testing the semiconductor wafer.

9. The method of claim 1, wherein the manufacturing process is a process in at least one of semiconductor fabrication or manufacturing an electronic device.

10. A computer readable medium comprising instructions which, when executed by a processor in a computing system, perform an operation, the operation comprising:
detecting a drift in input data used in a digital twin of a manufacturing process, wherein the digital twin comprises an initial artificial intelligence (AI) model; and
upon determining that a first one of a plurality of already trained AI models, or a first one of a plurality of previously trained branches in the initial AI mode, was trained using a data distribution that is similar to the drift in the input data, selecting the first trained AI model or the first branch in the initial AI model to use in the digital twin.

11. The computer readable medium of claim 10, wherein operation further comprises, before detecting the drift in the input data:
building the plurality of trained AI models or the plurality of trained branches from different data distributions representing different predicted scenarios that can occur in the manufacturing process.

12. The computer readable medium of claim 11, wherein the different predicted scenarios comprises at least one of:
a deterioration of a tool used in the manufacturing process;
a change of material used in the manufacturing process; or
a change of design of a product produced by the manufacturing process.

13. The computer readable medium of claim 11, wherein the operation further comprises, before building the plurality of trained AI models or the plurality of trained branches:
synthesizing data, using an AI synthesizer, based on predicted drifts in a historical data distribution corresponding to the manufacturing process, wherein the different data distributions comprise the synthesized data.

14. The computer readable medium of claim 10, wherein the operation further comprises, after selecting the first trained AI model or the first branch:
detecting a second drift in the input data used in the digital twin; and
upon determining that none of the plurality of already trained AI models, or none the plurality of previously trained branches in the initial AI mode were trained using a data distribution that is similar to the second drift in the input data, determining whether the second drift is abrupt based on one or more threshold;
the operation further comprises one of:
upon determining that the second drift is not abrupt, retraining the initial AI model using current and historical input data received at the digital twin; or
upon determining that the second drift is abrupt:
synthesizing training data; and
building, using the synthesized data, a new AI model to replace the initial AI model in the digital twin.

15. A computing system comprising:
one or more processors;
one or more computer-readable storage media; and program instructions stored on the one or more storage media to cause the one or more processors to perform operations comprising:
detecting a drift in input data used in a digital twin of a manufacturing process, wherein the digital twin comprises an initial artificial intelligence (AI) model; and
upon determining that a first one of a plurality of already trained AI models, or a first one of a plurality of previously trained branches in the initial AI mode, was trained using a data distribution that is similar to the drift in the input data, selecting the first trained AI model or the first branch in the initial AI model to use in the digital twin.

16. The computing system of claim 15, wherein the operations further comprise, before detecting the drift in the input data:
building the plurality of trained AI models or the plurality of trained branches from different data distributions representing different predicted scenarios that can occur in the manufacturing process.

17. The computing system of claim 16, wherein the different predicted scenarios comprises at least one of:
a deterioration of a tool used in the manufacturing process;
a change of material used in the manufacturing process; or
a change of design of a product produced by the manufacturing process.

18. The computing system of claim 16, wherein operations further comprise, before building the plurality of trained AI models or the plurality of trained branches:
synthesizing data, using an AI synthesizer, based on predicted drifts in a historical data distribution corresponding to the manufacturing process, wherein the different data distributions comprise the synthesized data.

19. The computing system of claim 15, wherein the first trained AI model replaces the initial AI model in the digital twin, or selecting the first branch to use in the digital twin results in a second, initial branch in the initial AI model no longer being used.

20. The computing system of claim 15, wherein the operation further comprises, after selecting the first trained AI model or the first branch:
detecting a second drift in the input data used in the digital twin; and
upon determining that none of the plurality of already trained AI models, or none the plurality of previously trained branches in the initial AI mode were trained using a data distribution that is similar to the second drift in the input data, determining whether the second drift is abrupt based on one or more threshold;
the operations further comprise one of:
upon determining that the second drift is not abrupt, retraining the initial AI model using current and historical input data received at the digital twin; or
upon determining that the second drift is abrupt:
synthesizing training data; and
building, using the synthesized data, a new AI model to replace the initial AI model in the digital twin.
